(19) United States
(12) Patent Application Publication
(10) Pub. No.: US 2009/0105412 A1
(43) Pub. Date: Apr. 23, 2009

(54) Polyamides for vehicular parts

(76) Inventors: Marvin M. Martens, Vienna, WV (US); Ahmet Turgut Mutel, Napanee (CA)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/283,528

(22) Filed: Sep. 12, 2008

Related U.S. Application Data
(60) Provisional application No. 60/993,814, filed on Sep. 13, 2007.

(51) Int. Cl. C08L 77/00; C08G 69/08

(52) U.S. Cl. 524/607; 528/331

(57) ABSTRACT

Polyamides made from a combination of adipic acid, terephthalic acid and 1,6-hexanediamine in specified proportions have excellent salt stress corrosion cracking resistance. These polyamides are especially useful for vehicular parts that are exposed to contact with salts such as sodium chloride or calcium chloride that are used, for instance, for melting ice and/or snow on roadways.

### CROSS REFERENCE TO RELATED APPLICATIONS

This application claims the benefit of U.S. Provisional Application No. 60/993,814, filed Sep. 14, 2007.

### FIELD OF THE INVENTION

Polyamides containing repeat units derived from 1,6-hexanediamine, adipic acid and terephthalic acid are especially resistant to salt stress corrosion cracking and particularly useful for vehicular parts which are exposed to salts.

### TECHNICAL BACKGROUND

Polymeric materials, including thermoplastics and thermosets, are used extensively in automotive vehicles. They are light and relatively easy to fashion into complex parts, and are therefore preferred instead of metals in many instances. However a problem with some metal alloys and some polymers is salt stress (induced) corrosion cracking (SSCC), where a part under stress undergoes accelerated corrosion when under stress and in contact with inorganic salts. This often results in cracking and pre-mature failure of the part.

Polyamides such as polyamide 6,6 and polyamide 6 have been made into and used as vehicular parts. These polyamides are prone to SSCC in such uses, because various sections of vehicles and their components are sometimes exposed to salts, for example salts such as sodium chloride or calcium chloride used to melt snow and ice in colder climates. Thus polyamide compositions with better resistance to SSCC are desired.

The use of polymers containing repeat units (I) and (II) in vehicles has been reported, see for instance U.S. Pat. Nos. 4,937,276, 5,891,987, and 6,656,589, U.S. Patent Publication 2007016174, and Japanese Patent Application 04239531. None of these publications specifically mentions using these polyamides in parts of the vehicle where they would be exposed to salt.

### SUMMARY OF THE INVENTION

This invention concerns a vehicular part, comprising a polyamide whose repeat units consist essentially of about 10 to about 35 molar percent of repeat units of the formula

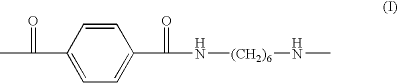

and about 90 to about 65 molar percent of repeat units of the formula

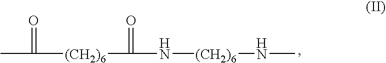

provided that in normal operation said vehicular part is exposed to salt.

This invention also concerns a vehicle, comprising a part, comprising a polyamide whose repeat units consist essentially of about 10 to about 35 molar percent of repeat units of the formula

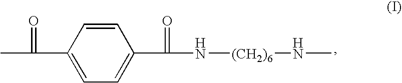

and about 90 to about 65 molar percent of repeat units of the formula

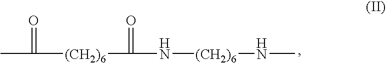

provided that in normal operation said part is exposed to salt.

### DETAILS OF THE INVENTION

Herein several terms and phrases are used, and some of them are defined below:
By a “vehicle” is meant any device which moves which is on wheels and transports people and/or freight or performs other functions. The vehicle may be self propelled or not. Applicable vehicles include automobiles, motorcycles, wheeled construction vehicles, farm or lawn tractors, trucks, and trailers. Preferred vehicles are automobiles, trucks, and motorcycles.
By “in normal operation said part is exposed to salt” is meant that when tested in a normal vehicle configuration (as supplied by the manufacturer with all OEM guards in place, but no additional equipment present), the part is not wet or otherwise exposed to a water solution in the following test. The vehicle is driven (or towed if not self propelling) at 50 km/h (˜30 mph) for 20 meters through a trough (so that all wheels go through the water or water solution) filled with water or a solution of a “marker” in water which is 1.5 cm deep. The part being tested is then checked to see if it is wet. If the part is wet it is considered exposed to salt in normal operation. If the part is normally hot in operation and the water would evaporate quickly, a marker sub-stance is used in the water and part checked for the marker. The marker may be a salt (a white salt deposit will remain) of a chemical such as fluorescein which can be checked for using ultraviolet light. If the marker chemical is on the part, the part is considered as exposed to salt in normal operation. This test simulates moving on a highway that may be covered with salt particles that is melting ice or snow and/or a salt solution, and the resulting saltwater spray which is thrown onto the vehicle.

Repeat unit (I) of the polyamide is derived from 1,6-hexanediamine and terephthalic acid, while repeat unit (II) is derived from 1,6-hexanediamine and adipic acid. Preferably the molar percentage of repeat unit (I) is about 15% to about 35%, more preferably about 20% to about 30%, with repeat unit (II) being the remainder of the repeat units present. Another preferred range for unit (I) is 15 to 20 mole percent. The polyamide can be made by methods well known in the art for making polyamides, see for instance U.S. Pat. Nos. 5,891,987 and 6,656,589, and Japanese Patent Application 04239531, all of which are hereby included by reference. It is preferred that the polyamide have a melting point of less than 285° C. (see below for method for measuring the melting point). By having a melting point below 285° C. the polyamide may be made in facilities in which polyamide 6,6 can be made, a distinct advantage since these facilities are therefore able to make two different products.

The polyamide may contain other substances normally found in polyamide compositions such as fillers and reinforcing agents, dyes, pigments, stabilizers, antioxidants, nucleating agents, flame retardants, tougheners, lubricants and mold release agents. Useful fillers and reinforcing agents include inorganic minerals such as clay, talc, wollastonite, and mica, and other materials such as glass fiber, glass flake, milled glass fiber, aramid fiber, carbon fiber, and carbon black. Preferred fillers/reinforcing agents are glass fiber and inorganic mineral fillers. These polyamide compositions may be made by conventional means such as melt mixing (the polyamide is melted) in a single or twin screw extruder. Parts may be formed from the polyamide (composition) by any method usually used for thermoplastics, such as injection molding, extrusion, compression molding, thermoforming, and rotational molding.

Useful vehicular parts include cooling system components, intake manifolds, oil pans, transmission cases, electrical and electronic housings, fuel system components, filter housings, coolant pump covers, and radiator end tanks, provided of course that the particular part is exposed to salt in normal vehicle operation.

Melting Points: In the Examples melting points and glass transition temperatures are measured using ASTM Method ASTM D3418 at a heating rate of 10° C./min. On the second heat the melting point is taken as the peak of the melting endotherm, and the glass transition temperature is taken at the transition midpoint.

Salt stress Corrosion Test: Bars having dimensions of 120×12.7×2.5 cm were cut from a plaques so that the long dimension of the bar was perpendicular to the flow direction during molding. The bars were preconditioned in 100° C. water for 4 hours before the test.

The bars were then clamped horizontally at one end in a jig so that 30.8 mm of the length was clamped and 89.2 mm was hanging unsupported. A 450 g weight was applied to the far end (away from the clamp) of the bar, to give a stress of about 300 kg/cm² at the edge of the clamp. A gauze soaked with aqueous 45 weight percent CaCl₂ solution was applied at the start of the overhang (near the clamp) and covered about 50 mm of the unsupported section of the bar. The apparatus was held at 100° C. for two hours and then at 23° C. for one hour, then appearance was checked visually. The CaCl₂ solution soaked gauze was changed after each cycle. The cycle was then repeated up to a total of 30 times, depending on whether the bar broke or not. The higher the number of cycles the bar lasted and/or the lower amount of damage observed, the better the resistance to SSCC.

In the Examples the following materials were used:
3660 Glass Fiber—PPG® 3660 chopped glass fiber, available from PPG Industries, Pittsburgh, Pa. 15272.
Licowax® OP—A partly soaponified montan derived wax available from Clariant Gmbh, 86005 Augsburg, Germany.
Polyamide A—a polyamide 6,6, Zytel® 101 NC010 available from E. I DuPont de Nemours & Co., Inc., Wilmington, Del. 19898 USA.
Polyamide B—A copolyamide having 80 mole percent units derived from 1,6-hexandiamine and adipic acid and 20 mole percent of units derived from 1,6-hexanediamine and terephthalic acid.
Polyamide C—A copolyamide having 75 mole percent units derived from 1,6-hexandiamine and adipic acid and 25 mole percent of units derived from 1,6-hexanediamine and terephthalic acid.
Polyamide D—A copolyamide having 70 mole percent units derived from 1,6-hexandiamine and adipic acid and 30 mole percent of units derived from 1,6-hexanediamine and terephthalic acid.
Polyamide E—a polyamide 6, Ultramid® B27 E 01 available from BASF Corp., Florham Park, N.J. 07932 USA.
Stabilizer—7:1:1 (weight ratio) of potassium iodide:copper iodide:aluminum stearate.

### Examples 1-3 and Comparative Examples A-B

Five different polyamide compositions were prepared by melt-blending in a twin screw nine-barrel extruder all the ingredients. All ingredients were added to the barrel furthest from the die, except for glass fiber which was added to the 6^{th} barrel from the feed throat. The temperature of the 2^{nd} barrel from the feed throat was set at about 230° C. for all the Examples and Comparative Examples. The remaining barrels for Examples 1-3 and Comparative Example A were set at temperature of 300-310° C. and the die temperature was set at about 290° C. For Comparative Example B the remaining barrels and die head were set at about 260° C. The compositions are listed in Table 1 were compounded in a 40 mm Werner & Pfleiderer co-rotating twin screw extruder at the rate of 82 kg/hour. They were then molded injection molded into plaques 140×120×2.5 mm on a Toshiba 170 ton injection molding machine. Melt Temperatures for injection molding were 290-310° C. for Examples 1-3 and Comparative Example A and 215-225° C. for Comparative Example B. Mold temperatures were 80-120° C. for Examples 1-3 and Comparative Example A, and 70-90° C. for Comparative Example B. Bars were cut from the plaques as described above and tested for SSCC. Duplicate tests were run and results are in Table 2.

TABLE 1^{a}

| Ex. | A | 1 | 2 | 3 | B |
|---|---|---|---|---|---|
| Polyamide A | 64.25 | | | | |
| Polyamide B | | 64.25 | | | |
| Polyamide C | | | 64.25 | | |
| Polyamide D | | | | 64.25 | |
| Polyamide E | | | | | 64.25 |
| Stabilizer | 0.5 | 0.5 | 0.5 | 0.5 | 0.5 |
| 3360 Glass Fiber | 35 | 35 | 35 | 35 | 35 |
| Licowax ® OP | 0.25 | 0.25 | 0.25 | 0.25 | 0.25 |

^{a}All parts by weight.

TABLE 2

| | | Cycles to:^{a} | | | | |
|---|---|---|---|---|---|---|
| | | Slightly | | | | |
| | | Wrinkled | Obvious | Slight | | |
| Ex. | Sample | Surface | Crease | Cracking | Cracking | Broken |
| A | 1 | | 1 | | 5 | 11 |
| | 2 | 1 | | 4 | 5 | 18 |
| 1 | 1 | 1 | 10 | 27 | | |
| | 2 | 8 | 10 | 29 | | |
| 2 | 1 | 6 | 11 | 30 | | |
| | 2 | 6 | 11 | 30 | | |
| 3 | 1 | 6 | 13 | | | |
| | 2 | 6 | 13 | 30 | | |
| B | 1 | | | | 1 | 2 |
| | 2 | | | | | 1 |

^{a}First cycle after which this condition was observed.

These results show that the combination of repeat units (I) and (II) in a polyamide give much improved SSCC resistance when compared to other polyamides.

What is claimed is:

1. A vehicular part, comprising a polyamide whose repeat units consist essentially of about 10 to about 35 molar percent of repeat units of the formula 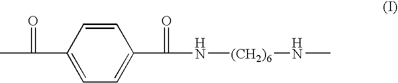
and about 90 to about 65 molar percent of repeat units of the formula 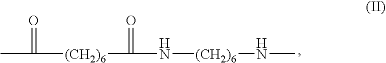
provided that in normal operation said vehicular part is exposed to salt.

2. The vehicular part as recited in claim 1 wherein said repeat units of formula (I) are about 20 to about 30 mole percent of said polyamide, and said repeat unit of the formula (II) are about 80 to about 70 mole percent of said polyamide.

3. The vehicular part as recited in claim 1 wherein said repeat units of formula (I) are about 15 to about 20 mole percent of said polyamide, and said repeat unit of the formula (II) are about 85 to about 80 mole percent of said polyamide.

4. The vehicular part as recited in claim 1 wherein said polyamide also contains one or more of glass fiber and/or mineral filler.

5. The vehicular part as recited in claim 1 wherein said vehicular part is a cooling system component, intake manifold, oil pan, transmission case, electrical or electronic housing, fuel system component, filter housing, coolant pump cover, or radiator end tank.

6. A vehicle comprising the vehicular part of claim 1.

6. A vehicle comprising the vehicular part of claim 2.

7. A vehicle comprising the vehicular part of claim 3.

8. A vehicle comprising the vehicular part of claim 4.

9. A vehicle comprising the vehicular part of claim 5.
